(19) United States
(12) Patent Application Publication
(10) Pub. No.: US 2011/0006050 A1
(43) Pub. Date: Jan. 13, 2011

(54) Thermally Heated Collapsible Sun shade

(76) Inventors: Joseph Patrick Nee, Calhan, CO (US); Sean Cody Bolduc, Colorado Springs, CO (US)

Correspondence Address: JOSEPH P. NEE, 23590 MCDANIELS RD, CALHAN, CO, 80808, US

(21) Appl. No.: 12/834,849

(22) Filed: Jul. 12, 2010

Related U.S. Application Data
(60) Provisional application No. 61/225,167, filed on Jul. 13, 2009.

(51) Int. Cl. B60L 1/02

(52) U.S. Cl. 219/203

(57) ABSTRACT

The present invention is a heated sun shield assembly that has suction cups which attach the shield to the windshield of an automobile. The shade has a flexible opaque heated sheet that is attached to a flexible frame. The frame is designed and can be folded and twisted into a plurality of concentric loops that can be placed in a pouch for storage. The opaque sheet has affixed to one surface, a thermal electric foil or conductive ink grid, which connects to 12-volt supply wires, a 12-volt cigarette lighter adapter and a timer delay mechanism. Therefore it is the object of the present invention to provide a collapsible or roll up heated sun shield assembly that can shade the interior of an automobile as well as defrost the windshield.

Various other modifications will be apparent and readily made by those skilled in the art without departing from the scope and spirit of the invention

### CROSS-REFERENCE TO RELATED APPLICATIONS

None

### FEDERALLY SPONSORED RESEARCH

None

### SEQUENCE LISTING

None

### BACKGROUND OF INVENTION

### Field of Invention

The present invention relates to a collapsible sun shield/auxiliary automotive windshield defroster. Specifically, the invention relates to a removable, collapsible self-storing automotive windshield for winter use prior to vehicle start up.

Most defrosting units currently in the art employ systems which in corporate and relay on engine heat and delivery systems to provide sufficient heat and placement to melt snow, ice and frost from automotive windshields. Thus what is needed in the art is a auxiliary and removable collapsible self storing defrosting system capable of utilizing thermal sheeting, timers and the vehicles electrical system to initiate pre-warming and defrosting of the windshield.

### SUMMARY

The present invention relates to an automotive windshield defrosting system which may be incorporated into collapsible or retractable storage devices and employs use of available vehicle system for power and a thermostat and timer to restrict and control energy usage. In one aspect of the invention, the defroster includes the use of a thermal heating grid affixed to collapsible sun shields or retractable shades. In another aspect of the invention, the defroster incorporates a self-storing retractable thermal shield or blanket. In another arrangement, the apparatus employs a timer and thermostat to control and restrict the energy consumption while providing sufficient heating capacity and vehicle start up power.

### DRAWING DESCRIPTIONS 1-2-3-4-5-6-7-8

The accompanying drawings, which are incorporated into and form part of the specifications, illustrate several embodiments of the present invention and together with the description, serve to explain the principles of invention.

### DRAWINGS

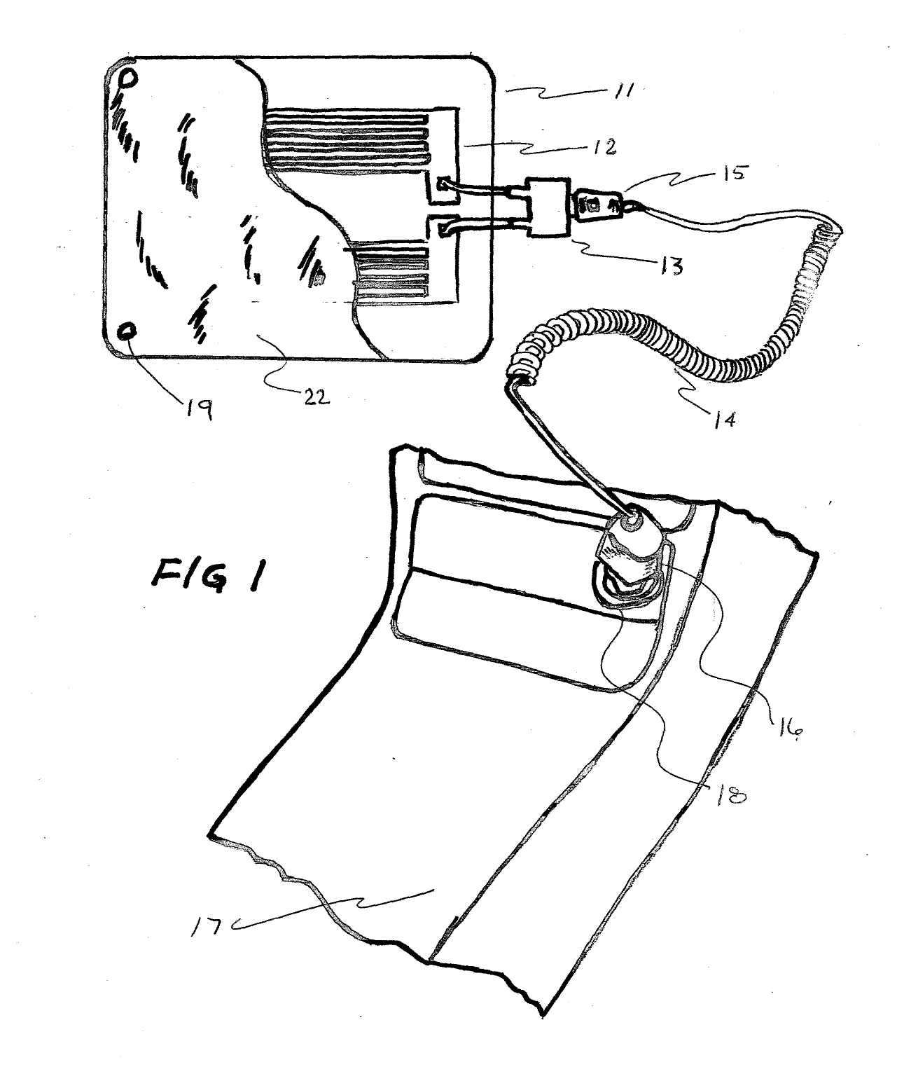

FIG. 1 is a perspective view of the embodiment of the defrosting sunshade, showing the shade (11), cord (14), timer and cigarette adapter.

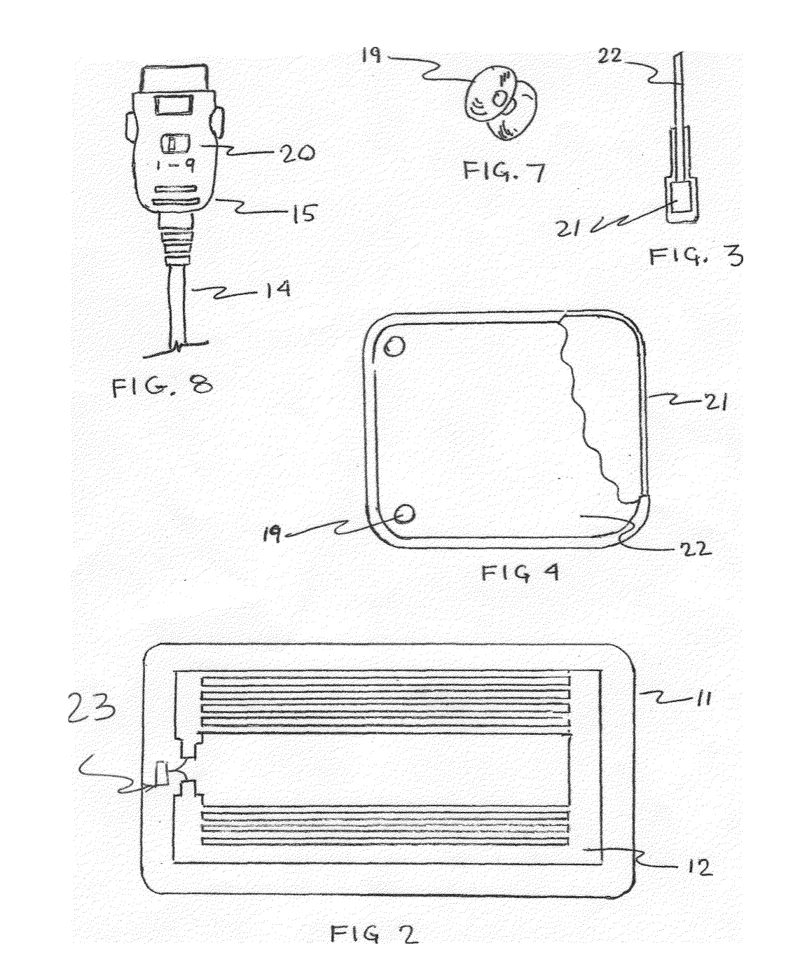

FIG. 2 is a perspective view of the heating grid detail.

FIG. 3 is a perspective view of the frame cross-section.

FIG. 4 is a perspective view of the shade.

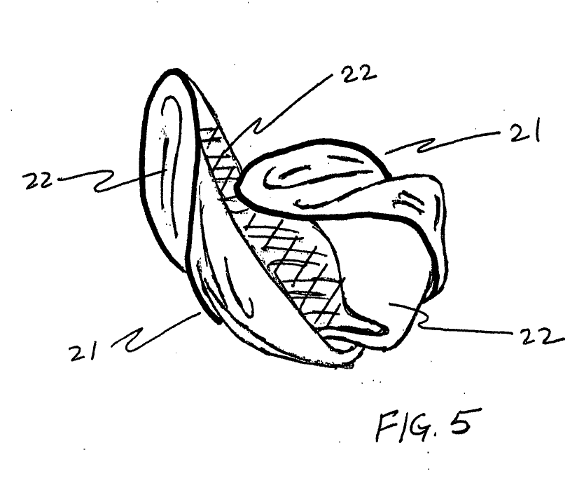

FIG. 5 is a perspective view of the collapsible sunshade partially folded

FIG. 6 is a perspective view of the cord, timer, and cigarette adapter.

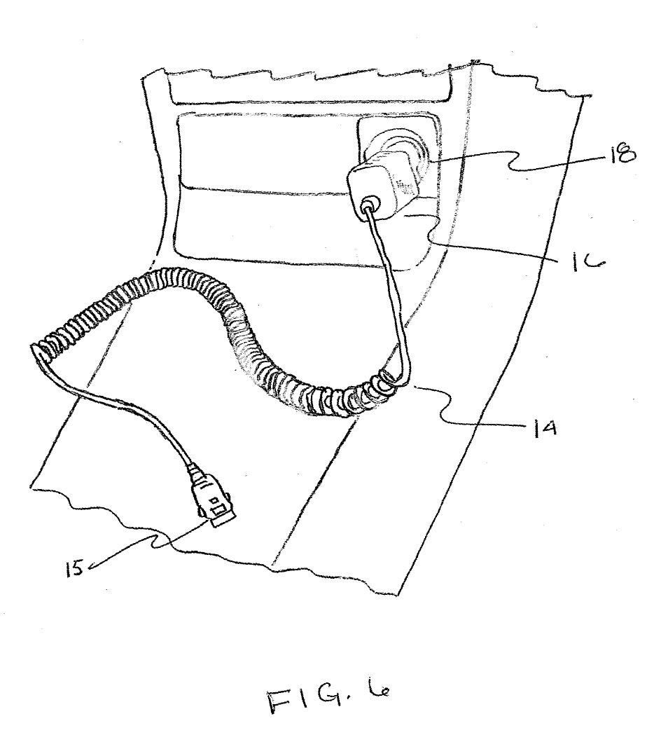

FIG. 7 is a perspective view of the suction cups.

FIG. 8 is a perspective view of the timer plug end of supply cord.

### DETAILED DESCRIPTION

Referring to the drawings more particularly by reference numbers.

FIG. 1 shows a heated sun shade (11) constructed according to a preferred embodiment of the invention includes a flexible thermal heating element (12) or grid comprised of a suitable conductive foil or any other conductive material or fluid affixed to one side of sun shade fabric (22) in the illustrated embodiment, the conductive grid (12) forms a circuit and the power cord (14) provides current to the circuit. As the current travels along the circuit, however, the circuit short circuits to thereby generate heat. The grid and various electric components can perform any other suitable manner to generate heat in any suitable manner in accordance with the other embodiments. As shown in FIG. 3 each shade has a flexible sheet (22). The frame (22) is constructed of a single strip that is bent into a closed loop. The strip is constructed of a spring like metal or plastic that can be readily twisted or folded without yielding the material. In a preferred embodiment the frame (22) is constructed from steel wire, which is both flexible and strong.

As shown in FIG. 2 a thermal grid (12).

As shown in FIG. 8 plug end (15) with variable delay timer (20) in one embodiment the plug end (12) houses a slide able variable delay timer (20). In another embodiment the plug end (15) incorporates a programmable delay mechanism.

As shown in FIG. 5 the collapsible thermal shade shown is partially folded. The shade (11) has a flexible opaque sheet (22) that is attached to a flexible frame (21). The frame (21) is constructed to be folded and twisted into a plurality of concentric loops. The preferred method of collapsing the thermal shade (11) include the user holding the opposite sides of the frame (21) with both hands and twist the sides in opposite directions, while folding the shade inward until both ends form three overlapping loops.

As shown in FIG. 7 the invention includes a pair of suction cups (19) which affix the thermal sun shade (11) to the windshield or glass windows of an automobile. In one embodiment the suction cups (19) are attached to the frame (21). The suction cups (19) are typically constructed from rubber and are adapted to create a vacuum when depressed onto a smooth object. The suction cups (19) are designed to hold the thermal shun shade (11) a specific distance from the glass surface for optimum defrosting capabilities.

### REFERENCE NUMERALS

11 heated sun shade
12 heating element
13 shade plug adapter
14 power cord
15 plug with controller
16 cigarette adapter
17 vehicle console
18 cigarette lighter socket
19 suction cup
20 programmable controller
21 flexible sun shade frame
22 sun shade fabric
23 universal grid plug

### OPERATION

In operation one uses the embodiment of the invention by first unfolding the sun shade 11 such that the coiled frame 21 is fully deployed
1. the sun shade 11 is thereby placed against the windshield such that the rubber suction cups 19 are placed against the windshield near the top edge and behind the rear view mirror and the shade plug adapter 13 is located at the bottom
2. the power cord is thence attached to the sun shade 11 and the programmable device 20 is set
3. the cigarette lighter adapter plug 16 is then inserted into the lighter socket 18
4. whence the current is transferred from the vehicles electrical system through the power cord 14 to the thermally heated conductive ink or foil grid within the sun shade
5. the electrical current by means of resistance produces a thermal release which defrosts the windshield.

What is claimed is:

1. A heated automotive sunshade for defrosting windshields, further including a means for converting electrical energy into heat.

2. the heated sunshade of claim 1 comprising a sheet of flexible opaque material
a. a conductive grid affixes to the flexible opaque material comprising conductive ink, foil or any suitable variant.
b. A system of connections from the grid terminated at a universal plug

3. the heated sun shade of claim 1 that comprising a power cord, such that electrical energy is conducted from a power source to the sunshade
a. a system of adapters at each end of said power cord

4. the opaque flexible material material of claim 2 comprising a plurality of suctions cups whereby the said sunshade is affixed to the windshield.

5. the power cord of claim 3 comprising a means and method for alternately attaching a power source to the sunshade.

6. the power cord of claim 3 comprising a device as a means for regulating a delayed delayed activation of heat from said conductive grid.
a. a plurality of means to input and program said device for time delay activation, low volts/amps auto shut off.

7. the device of claim 6 further includes a means of sensing the status in volts or amps of a power source.

8. the invention of claim 1 comprises a sheet of flexible opaque material which is collapsible and flexible by means of thin wire frame and folds into a plurality of concentric loops
